(19) United States
(12) Patent Application Publication
(10) Pub. No.: US 2017/0264907 A1
(43) Pub. Date: Sep. 14, 2017

(54) METHOD OF ENCODING AND DECODING A VIDEO OF A DRONE, AND ASSOCIATED DEVICES

(71) Applicant: PARROT DRONES, Paris (FR)

(72) Inventors: Aurelien Barre, Paris (FR); Jerome Bouvard, Berkeley, CA (US); Henri Seydoux, Paris (FR)

(21) Appl. No.: 15/415,428

(22) Filed: Jan. 25, 2017

(30) Foreign Application Priority Data
Mar. 9, 2016 (FR) 16 51965

(51) Int. Cl. H04N 19/44; H04N 7/18; B64C 39/02; B64D 47/08; H04N 19/46; G05D 1/00

(52) U.S. Cl. CPC H04N 19/44; H04N 19/46; G05D 1/0011; B64C 39/024; B64D 47/08; H04N 7/183; B64C 2201/127; B64C 2201/146

(57) ABSTRACT

The invention relates to a method of dynamically encoding flight data in a video, implemented in a drone, the drone comprising a video sensor and attitude sensors and/or altitude sensors. This method comprises, for successive images captured, a step of capturing flight data (E22) of the drone from the attitude sensors and/or the altitude sensors and a step of encoding the captured image (E23). It further includes a step of storing (E24), in a data container, the encoded image, a step of adding (E25) to the encoded image, in the data container, all or part of the flight data captured, and a step of storing (E26) said data container in a memory of the drone (10), and/or of transmission (E27), by the drone (10), of said data container to a remote device (16). The encoding of the video images comprises an MPEG-4 encoding (ISO/IEC 14496), and the data container is a track according to MPEG-4 Part 12, multiplexing according to a common clock said encoded image and said associated flight data.

The invention relates to a method of dynamically encoding flight data in a video implemented in a drone and a drone having on board a camera and other sensors comprising such an encoding method. The invention also relates to a video decoding method and a visualization device comprising such a decoding method.

The Bebop Drone and the Disco of Parrot or the eBee of SenseFLy are typical examples of drones. They are equipped with a series of sensors (accelerometers, 3-axis gyrometers, altimeter) and at least one camera. This camera is for example a vertical-view camera capturing an image of the overflown terrain or a front-view camera capturing an image of the scene towards which the drone is directed. These drones are provided with one motor or with several rotors drive by respective motors adapted to be controlled in a differentiated manner in order to pilot the drone in attitude and speed.

Other examples of drones are the rolling drones such as the Jumping Sumo MiniDrone of Parrot and the floating drones such as the Hydrofoil drone of Parrot.

The front video camera can be used for an “immersive mode” piloting of the drone, i.e. where the operator uses the image of the camera in the same way as if he were himself on board the drone. It may also serve to capture sequences of images of a scene towards which the drone is directed, the operator using the drone in the same way as a camera that, instead of being held in hand, would be borne by the drone. The images collected can be recorded, put online on web sites, sent to other Internet users, shared on social networks, etc.

The WO 2010/061099 A2, EP 2 364 757 A1 and EP 2 450 862 A1 (Parrot) describe the principle of piloting a drone through a touch-screen multimedia telephone or tablet having an integrated accelerometer, for example a smartphone of the iPhone type or a tablet of the iPad type (registered trademarks).

In the following of the description, the term “piloting device” will generally be used to denote this apparatus, but this term must not be understood in its narrow meaning; on the contrary, it also includes the functionally equivalent devices, in particular all the portable devices provided with at least one visualization screen and with wireless data exchange means, such as smartphone, etc.

The piloting device incorporates the various control elements required for the detection of the piloting commands and the bidirectional exchange of data via a radio link of the Wi-Fi (IEEE 802.11) or Bluetooth wireless local network type, established directly with the drone. Its touch screen displays the image captured by the front camera of the drone, with in superimposition a number of symbols allowing the control of the flight and the activation of commands by simple contact of the operator's finger on this touch screen.

The bidirectional wireless radio link comprises an uplink (from the piloting device to the drone) and a downlink (from the drone to the tablet) to transmit data frames containing:
(from the piloting device to the drone) the piloting commands, hereinafter simply denoted “commands”, sent at regular intervals and on a systematic basis;
(from the drone to the piloting device) the video stream coming from the camera; and
(from the drone to the piloting device) as needed, flight data established by the drone or state indicators such as: battery level, phase of flight (takeoff, automatic stabilization, landed on the ground, etc.), altitude, detected fault, etc.

To allow such a communication, the drone comprises a communication means connected to an antenna so as to allow a communication with the piloting device. The antenna is for example a WiFi antenna.

The invention more particularly relates to a method of dynamically encoding images of a sequence of images captured by the camera on board a drone with the context of capture of the image, for them to be memorized, in order, for example, to reconstruct a posteriori the video of the scene visualized by the front camera or to be sent to be visualized by the operator on the device for piloting the drone in “immersive mode”.

Methods of memorizing video images in a drone for an analysis a posteriori are known. Likewise, it is known to memorize the drone flight context information.

However, these solutions have for drawback that the reconstruction of the flight video with integration of the flight information is uneasy and hence the result may be of low quality. This reconstruction is all the more difficult since it is necessary to reconstruct the video from a memorized image sequence and from flight context information unrelated to the image sequence.

The GB 2 519 645 A describes a drone used for the monitoring of forest fires. This drone sends separately the video flow and GPS data to a ground station, which then combines this information in successive packets, to allow the transmission to a remote-monitoring center via a packet switching network. That way, the addition of the flight data (the GPS data) to the encoded images is operated upstream by the remote station, after transmission by the drone.

The object of the present invention is to remedy the drawbacks of the existing solutions, by proposing a technique allowing in particular encoding the captured images and associated information in order, for example, to create a posteriori a video contextualized with the drone flight information.

That way, the invention proposes a method, implemented in a drone, of dynamically encoding flight data in a video, the drone comprising a video sensor and attitude sensors and/or altitude sensors. As disclosed by the above-mentioned GB 2 519 645 A, the method comprises, for successive images captured, a step of capturing flight data of the drone from the attitude sensors and/or the altitude sensors; and a step of encoding the captured image.

Characteristically, the encoding method further comprises: a step of storing, in a data container, the encoded image; a step of adding to the encoded image, in said data container, all or part of the captured flight data; and a step of storing said data container in a memory of the drone, and/or of transmission, by the drone, of said data container to a remote device.

Very advantageously, the step of encoding said video images comprises an MPEG-4 encoding (ISO/IEC 14496), and the data container is a track according to MPEG-4 Part 12, multiplexing according to a common clock said encoded image and said associated flight data.

The captured flight data may in particular comprise data of the group formed by: drone attitude data, drone altitude data, drone geolocation data, information relating to the flight phase, the flying speed and/or the position of the visualization window of the video sensor.

The invention also proposes a video decoding method, implemented in a drone video decoding or visualizing device, the video comprising a plurality of successive encoded images and flight data, stored together in a data container.

Characteristically, this method comprises, for encoded images: a step of extracting, from said container, an encoded image; a step of decoding the extracted image; and a step of extracting flight data associated with the image.

The invention also proposes a drone comprising a video sensor and attitude sensors and/or altitude sensors, adapted to implement the encoding method according to the described invention.

The invention also proposes a drone piloting device comprising means for piloting a drone and means for communicating with said drone, adapted to send flight commands and to receive data from said drone.

The piloting device comprises means for receiving from said drone a video comprising a plurality of encoded images and flight data, stored together in a data container, and means for implementing the decoding method according to the described invention.

The invention also proposes a drone video decoding device, the video comprising a plurality of encoded images and flight data, stored together in a data container, the device comprising means adapted to implement the decoding method according to the described invention.

An example of implementation of the present invention will now be described, with reference to the appended drawings.

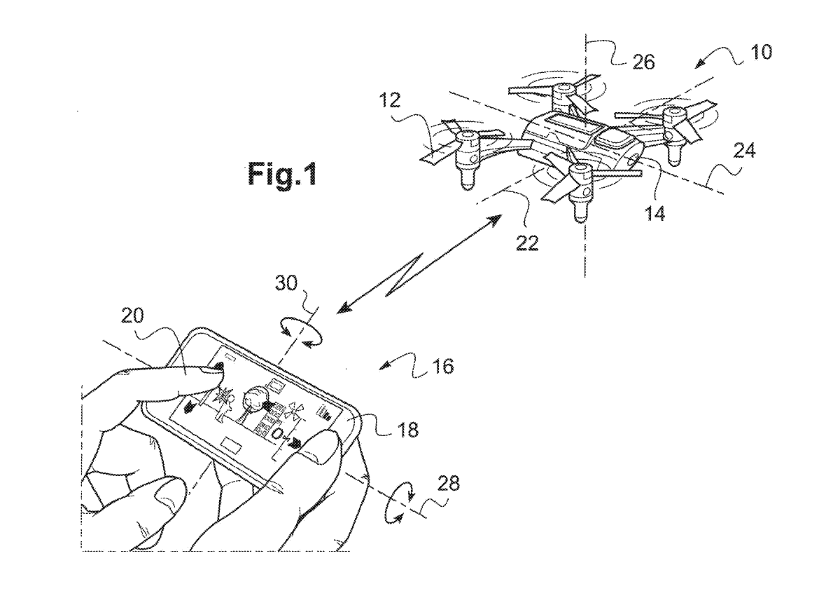

FIG. 1 is an overall view showing the drone and the associated piloting device allowing the piloting thereof.

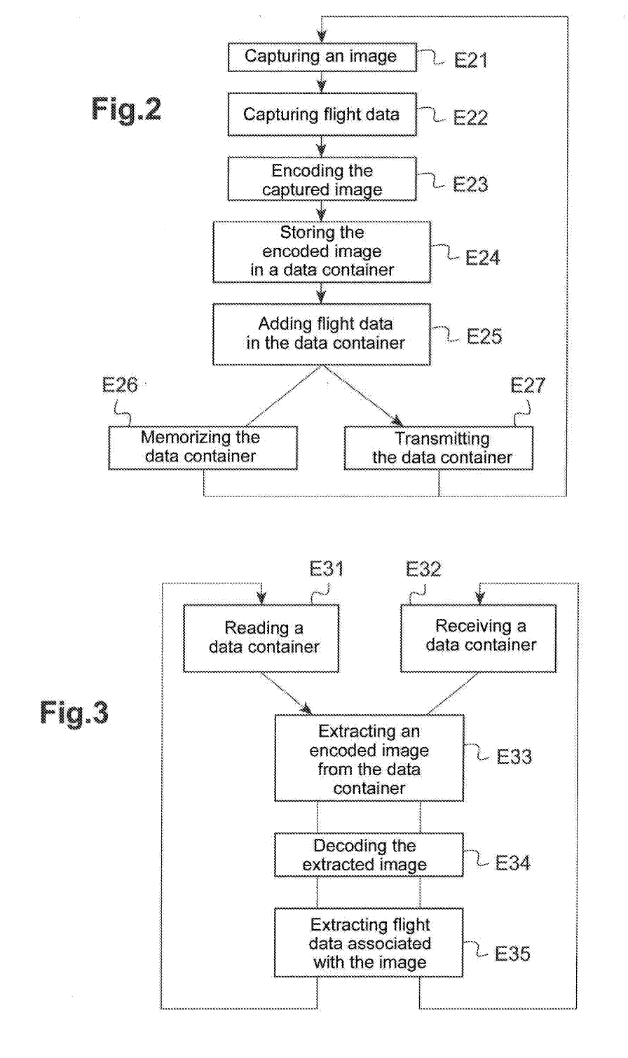

FIG. 2 illustrates a method of dynamically encoding flight data in a video according to the invention.

FIG. 3 illustrates a video decoding method according to the invention.

An example of implementation of the invention will now be described.

In FIG. 1, the reference 10 generally denotes a drone, which is for example a quadricopter such as the Bebop Drone model of Parrot. This drone includes four coplanar rotors 12 whose motors are piloted independently by an integrated navigation and attitude control system.

The invention also applies to a drone of the sailwing type, such as the Disco of Parrot, the eBee of SenseFly, or of the rolling drone type, such as the Jumping Sumo MiniDrone of Parrot or of the floating type such as the Hydrofoil drone of Parrot.

The drone is provided with a front-view video sensor 14 allowing obtaining an image of the scene towards which the drone is directed. The drone also includes a vertical-view video sensor (not shown) pointing downward, adapted to capture successive images of the overflown terrain and used in particular to evaluate the speed of the drone with respect to the ground. Inertial sensors (accelerometers and gyrometers) allow measuring with a certain accuracy the angular speeds and attitude angles of the drone, i.e. the Euler angles (pitch φ, roll θ and yaw ψ) describing the inclination of the drone with respect to a horizontal plane of a fixed terrestrial reference system. An ultrasonic range finder arranged under the drone moreover provides a measurement of the altitude with respect to the ground.

The drone may also comprise a geolocation module in order to be able to determine the position of the drone at each instant. This position is expressed in a format giving the latitude, the longitude and the altitude. During the flight, the drone is hence adapted to determine the position thereof at each instant.

The drone may also comprise a compass.

The drone 10 is piloted by a piloting device that is a remote-control apparatus 16 provided with a touch-screen 18 displaying the image captured by the front-view sensor 14, with in superimposition a number of symbols allowing the activation of piloting commands by simple contact of a user's finger 20 on the touch screen 18. The apparatus 16 is provided with means for radio link with the drone, for example of the Wi-Fi (IEEE 802.11) local network type, for the bidirectional exchange of data from the drone 10 to the apparatus 16 and from the apparatus 16 to the drone 10 for the sending of piloting commands.

According to the invention, this exchange comprises in particular the transmission from the drone 10 to the apparatus 16 of the image captured by the video sensor 14 and of the flight data such as the altitude, the drone geolocation, etc., reflecting the state of the drone at the image capture.

The piloting of the drone consists in making the latter evolve by:
a) rotation about a pitch axis 22, to make it move forward or rearward;
b) rotation about a roll axis 24, to move it aside to the right or to the left;
c) rotation about a yaw axis 26, to make the drone main axis pivot to the right or to the left; and
d) translation downward or upward by changing the gas control, so as to reduce or increase, respectively, the drone altitude.

According to the invention, the display of the video flow and of the flight data captured by the drone is made on the piloting device from data received in continuous (streaming) from the drone.

In order to optimize the bandwidth of the communication network and to improve the quality of the video images, it is provided to define a simple and open format of encoding of the captured images and the drone flight data, allowing, at the time of processing this information, the reconstruction of a video contextualized with the drone flight data. In other words, the images will be encoded and drone flight data will be associated with images of the image sequence forming the video.

That way, images of the video sequence will be memorized with flight data reflecting the state of the drone at the image capture.

According to a particular embodiment, the flight data are multiplexed with the images of the video sequence.

These data (images and flight data) may be memorized in a memory space installed in the drone in order to be processed a posteriori or to be sent, in particular in continuous (streaming), from the drone to the piloting device.

According to a particular embodiment, the encoding of the captured images is performed according to the MPEG-4 standard.

The flight data may contain for example all or part of the following data: the state of the drone (in flight, on the ground, in takeoff phase, in landing phase, etc.), the piloting mode used by the operator to pilot the drone (manual mode, automatic return to the takeoff point mode, programmed flight mode, “follow-me” mode, etc.), the date and time, the attitude data (pitch φ, roll θ and yaw ψ), the video sensor position data (video sensor inclination, video sensor sight axis direction, video sensor visualization window position), the time of exposure at the image capture, ISO sensitivity, level of reception of the WiFi signal, percentage of charge of the drone battery, altitude data, drone geolocation data (latitude, longitude and altitude), data of relative altitude with respect to the takeoff point, distance with respect to the takeoff point and flying speed.

For that purpose, according to the invention, a dynamic encoding method is implemented in the drone, so as to encode the captured images and to associate with encoded images drone flight data reflecting the state of the drone at the capture of these images.

A diagram illustrating this encoding method is shown in FIG. 2.

The dynamic, i.e., continuous, encoding method comprises a first step E21 of capturing an image from the video sensor.

The step E21 is followed by a step E22 of capturing drone flight data from sensors of the drone, for example attitude sensors and/or altitude sensors. The altitude sensors are for example a geolocation sensor, an ultrasonic range finder, or any other device adapted to determine the altitude of said drone. The flight data comprise one or several previously defined data.

The step E22 is followed by the step E23 of encoding the captured image. According to an embodiment of the invention, the image is encoded according to the MPEG-4 standard. This standard is also called ISO/CEI 14496. It is a standard about audiovisual object encoding.

The step E23 is followed by a step E24 consisting in storing the encoded image in a data container.

According to an embodiment, the data container is a track within the meaning of the MPEG-4 standard. As regards the format of the data container used in the MPEG-4 standard, this format is described in the MPEG-4 standard Part 12 (ISO/IEC 14496-12).

The data container allows multiplexing several media according to a common clock, for example one or several video tracks with one or several audio tracks. In the context of the invention and according to an example of implementation of the invention, a video track is multiplexed with a track of dated metadata.

The step E24 is followed by the step E25 of adding flight data captured at step E22 of the encoded image in the data container,

According to a particular embodiment, the encoded image and the associated flight data are memorized in a video container at step E26, the video container being memorized in a memory space contained in the drone.

In the embodiment in which the encoding is performed according to the MPEG-4 standard, this encoding standard is based on a video container. The video container allows gathering into a single file a video flow and other information, in particular the flight data associated with the images.

According to a particular embodiment, the flight data are memorized in metadata containers whose method of inclusion in the data container is defined by the MPEG-4 standard.

According to a particular embodiment in which the drone is piloted with visualization of the video on the piloting device, the method comprises a complementary step E27 of transmission of the data container comprising the encoded image and flight data reflecting the state of the drone at the capture of said image.

The above-described steps E26 and E27 are followed by the step E21 for the encoding of other captured images,

It is to be noted that the steps E21 to E23 may be executed in a different order, or even in parallel.

According to another embodiment, the step E23 consists in performing the encoding of the captured image according to two different encoding formats. In particular, the image is encoded according to a first encoding format allowing a high visual quality of the image to be maintained, in particular in order to memorize this encoded image in a video container and the image is encoded according to a second encoding format degrading the visual quality of the image in order to transmit this encoded image via the radio link, by the drone to the piloted device, for a visualization on the piloting device. This second format allows reducing the size of the encoded image that will be transmitted via the radio link between the drone and the remote device, for example the piloting device.

According to an exemplary embodiment, the first format is a 1080p format corresponding to a definition of image of 1920×1080, i.e. of 1080 lines of 1920 points each. The second format is a 360p format corresponding to a definition of image of 640×360, i.e. of 360 lines of 640 points each.

Hence, at step E23, the encoding of the captured image may be performed according to one of the two described formats or according to the two described formats, so as to allow a memorization of the image encoded with a good visual quality and/or a transmission of the image encoded with a lower quality.

The step E27 of transmission of the container containing data relating to the encoded image and captured flight data will now be described in more details.

The transmission of the encoded images with the associated flight data consists in emitting in continuous flow (streaming) the data containers created at the above-mentioned steps E21 to E25, from the drone to a remote device, in particular to the drone piloting device. Such a transmission allows the drone piloting device to visualize the images captured by the drone in real time and hence allows the piloting mode with visualization of the video on the piloting device.

The transmission of such data containers will also allow the piloting device to display the captured images as well as the flight data reflecting the state of the drone.

Hence, via these data containers, the flight data displayed on the piloting device are synchronous with the visualized images.

To perform the transmission of the data containers, the computer communication protocol RTP (Real-time Transport Protocol) may be used. This communication protocol allows the transport of data subjected to real-time constraints, such as video flows.

In particular, for the transmission of these data containers, and according to a particular embodiment, it will be used one or several RTP headers per container to be transmitted and one header extension per data container including the flight data. This particular embodiment allows avoiding a network congestion.

In order to optimize the bandwidth of the network, it is possible not to transmit all the data relating to the drone flight from the drone to the piloting device, but only a selection of such data relating to the flight. For example, the geolocation data and the drone flying speed may be transmitted not with each image but for example every six images.

According to a particular exemplary embodiment, flight data among the following list of data may be transmitted for each image via the data container: the drone attitude, the video sensor position data (video sensor inclination, video sensor sight axis direction, video sensor visualization window position), the time of exposure at the image capture and the ISO sensitivity.

The other flight data may be sent via the data container for example every six images. It is in particular the level of reception of the WiFi signal and/or the percentage of charge of the battery, the geolocation data, the drone altitude with respect to its takeoff point, the distance with respect to its takeoff point, the flying speed, the drone flight state and/or the drone piloting mode.

FIG. 3 illustrates the video decoding method implemented in a drone video visualizing device, either from the video container containing all the images encoded according to the method described in FIG. 2, or from data containers received in continuous from the drone.

Hence, according to a first mode of implementation of the video decoding method, this method is implemented in a device for visualizing a video or a device for processing a video from the video container containing all the data containers in which are respectively stored the encoded image and the drone flight data reflecting the drone state at the image capture. Hence, the decoding method may comprise a first step E31 of reading a data container to be decoded.

According to a second mode of implementation of the video decoding method, this method is implemented in a video visualization device, and in particular in a drone piloting device at the reception of streams of data containers in which are respectively stored the encoded image and the drone flight data at the image capture. Hence, the decoding method may include a first step E32 of reception of a data container to be decoded, transmitted by the drone.

The steps E31 and E32 are followed by a step E33 of extracting the encoded image from the data container.

The step E34 follows the step E33. At step E34, the method performs a decoding of the encoded image extracted.

This step is followed by a step E35 of extracting flight data associated with the image. According to an embodiment, the flight data associated with the image are stored in a metadata container of the data container.

The step E35 is then followed by the step E31 or E32 as a function of the embodiment implemented.

According to the invention, and according to an embodiment, the drone memorizes a video container containing on the one hand all the captured images encoded and on the other hand all the drone flight data at the time of the respective capture of each of the images. These flight data are for example memorized in a metadata container.

At the time of processing the video, in particular at the time of construction of a video film from the video container, it is possible to enrich the video film with information integrating the drone flight data. The invention allows a good synchronization of the display of the drone flight data with the drone images.

Given that the flight data are memorized in a specific sub-container, in particular a metadata container, it is also possible to extract the flight data from the video container and to create a drone flight data file taking up all the flight data memorized in the video container.

1. A method, implemented in a drone, of dynamically encoding flight data in a video, said drone comprising a video sensor and attitude sensors and/or altitude sensors, this method comprising, for successive images captured:
a step of capturing flight data (E22) of said drone from the attitude sensors and/or the altitude sensors; and
a step of encoding the captured image (E23),
characterized in that it further comprises:
a step of storing (E24), in a data container, the encoded image;
a step of adding (E25) to the encoded image, in said data container, all or part of the flight data captured; and
a step of storing (E26) said data container in a memory of the drone (10), and/or of transmission (E27), by the drone (10), of said data container to a remote device (16).

2. The encoding method according to claim 1, wherein:
step of encoding said video images comprises an MPEG-4 encoding (ISO/IEC 14496), and
the data container is a track according to MPEG-4 Part 12, multiplexing according to a common clock said encoded image and said associated flight data.

3. The encoding method according to claim 1, characterized in that the captured flight data comprise data of the group formed by: drone attitude data, drone altitude data, drone geolocation data, information relating to the flight phase, the flying speed and/or the position of the visualization window of the video sensor.

4. A video decoding method, implemented in a drone video decoding or visualizing device,
the video comprising a plurality of successive encoded images and flight data, stored together in a data container,
characterized in that the method comprises, for encoded images:
a step of extracting (E33), from said container, an encoded image;
a step of decoding (E34) the extracted image; and
a step of extracting (E35) flight data associated with the image.

5. A drone comprising a video sensor and attitude sensors and/or altitude sensors, characterized in that it comprises means for implementing an encoding method, implemented in a drone, of dynamically encoding flight data in a video, said drone comprising a video sensor and attitude sensors and/or altitude sensors,
this encoding method comprising, for successive images captured:
a step of capturing flight data (E22) of said drone from the attitude sensors and/or the altitude sensors; and
a step of encoding the captured image (E23),
characterized in that it further comprises:
a step of storing (E24), in a data container, the encoded image;
a step of adding (E25) to the encoded image, in said data container, all or part of the flight data captured; and
a step of storing (E26) said data container in a memory of the drone (10), and/or of transmission (E27), by the drone (10), of said data container to a remote device (16).

6. A drone piloting device, comprising:
means for piloting a drone; and
means for communicating with said drone adapted to send flight commands and to receive data from said drone,
characterized in that the piloting device comprises:
means for receiving from said drone a video comprising a plurality of encoded images and flight data, stored together in a data container; and
means for decoding said video according to a decoding method, implemented in a drone video decoding or visualizing device,
the video comprising a plurality of successive encoded images and flight data, stored together in a data container,
characterized in that the decoding method comprises, for encoded images:
a step of extracting (E33), from said container, an encoded image;
a step of decoding (E34) the extracted image; and
a step of extracting (E35) flight data associated with the image.

7. A drone video decoding device, the video comprising a plurality of encoded images and flight data, stored together in a data container, characterized in that the device comprises means for decoding said video according to a decoding method, implemented in a drone video decoding or visualizing device, the video comprising a plurality of successive encoded images and flight data, stored together in a data container,
characterized in that the decoding method comprises, for encoded images:
a step of extracting (E33), from said container, an encoded image;
a step of decoding (E34) the extracted image; and
a step of extracting (E35) flight data associated with the image.

8. The drone according to claim 5, wherein within the encoding method:
step of encoding said video images comprises an MPEG-4 encoding (ISO/IEC 14496), and
the data container is a track according to MPEG-4 Part 12, multiplexing according to a common clock said encoded image and said associated flight data.

9. The drone according to claim 5, wherein the captured flight data comprise data of the group formed by: drone attitude data, drone altitude data, drone geolocation data, information relating to the flight phase, the flying speed and/or the position of the visualization window of the video sensor.
